(19) United States
(12) Patent Application Publication
(10) Pub. No.: US 2002/0132674 A1
(43) Pub. Date: Sep. 19, 2002

(54) Stub shaft sealing

(76) Inventors: Christian Mohr, Koln (DE); Manfred Odermatt, Hennef (DE)

Correspondence Address: Gary A. Smith, Ford Global Technologies, Inc., One Parklane Blvd., 600 Parklane Towers East, Dearborn, MI, 48126, US

(21) Appl. No.: 10/055,233

(22) Filed: Jan. 25, 2002

(30) Foreign Application Priority Data
Oct. 25, 2000 (EP) 00123103.4

(51) Int. Cl. F16C 1/26; F16D 3/84

(52) U.S. Cl. 464/173

(57) ABSTRACT

The invention relates to a shaft boot (9) for sealing off the transition between a drive shaft (8) and a joint, especially a constant velocity joint (90) in the drive system of a motor vehicle. The shaft boot (9), which is preferably composed of a polyurethane foam, is secured by its first end (2) on the constant velocity joint, using a clamping ring (3), and by its second end (7) on the drive shaft (8), using a second clamping ring (6). Extending radially between the two ends of the shaft boot there is at least one fold (5), the second end (7) and this fold lying essentially at the same axial level. Thanks to its compact construction, the space for holding lubricating grease is minimized and the lubricating grease is fed back to the constant velocity joint during movements of the drive shaft (8).

### BACKGROUND OF INVENTION

The invention relates to a shaft boot for sealing off the transition between a drive shaft and a universal joint, such as a constant velocity joint, having a larger diameter than the drive shaft.

In a motor vehicle, universally jointed shafts transmit the motive power of the engine to the shafts and from there to the wheels. Arranged along these universally jointed shafts there are various constant velocity joints, which allow angular misalignment and, if appropriate, also axial displacement between the axes of rotation of the incoming and the outgoing shaft. Constant velocity joints of this kind are arranged, inter alia, in the vicinity of the wheels and are therefore exposed to disturbing influences and stresses from the environment, especially attack by stone impact. Good lubrication of the elements moving relative to one another must furthermore be ensured in the constant velocity joints.

The transition between a constant velocity joint and a drive shaft is therefore generally surrounded by a flexible shaft boot made of rubber or a similar flexible material in order to protect it and prevent lubricating grease from escaping by means of a seal. A shaft boot known from U.S. Pat. No. 4,392,838 is secured on the drive shaft by its second end by means of a clamping ring, while the first end is secured on the constant velocity joint of larger diameter. From the first end, the shaft boot, which is produced from a flexible material, e.g. rubber, first of all runs in the direction of the constant velocity joint and then bends back in the direction of the drive shaft, where it is secured by its second end. Between its two ends, the shaft boot thus has a single fold that runs concentrically around the drive shaft and points inward in the direction of the constant velocity joint. The extent of the shaft boot in the axial direction is considerable since the boot is folded primarily in the axial direction. Owing to its considerable axial overall length and shape, the shaft boot has a large free volume on the inside, the side facing the constant velocity joint and the drive shaft, in which volume lubricating grease from the joint can accumulate during the operation of the constant velocity joint. This lubricating grease is therefore not available for the lubrication of the parts of the joint that are in frictional contact, as actually intended, resulting in more rapid wear of the assembly.

A shaft boot is disclosed by U.S. Pat. No. 4,369,979. The shaft boot disclosed there is secured on a sleeve that can move axially on the drive shaft but is otherwise constructed in a manner similar to the shaft boot disclosed by U.S. Pat. No. 4,392,838. This shaft boot too is thus folded primarily in the axial direction and therefore has a large empty volume facing the interior, in which unwanted lubricating grease can accumulate.

### SUMMARY OF INVENTION

The object of the present invention is to improve a shaft boot of the type stated at the outset in such a way that it provides reliable and functionally improved sealing of the transition between the drive shaft and the joint in an economical manner.

The shaft boot according to the invention accordingly serves primarily to seal off the transition between a drive shaft and a joint, especially a constant velocity joint, in a motor vehicle, although it is also suitable for other applications supported in a similar manner.

The joint has a larger diameter than the drive shaft, and the shaft boot is secured by its first end on the joint and by its second end on the drive shaft. The shaft boot has at least one fold, which concentrically surrounds the drive shaft and preferably points away from the joint, and the second end of the shaft boot is secured approximately in the region of the axial extent of the fold.

The joint includes an encircling collar formed in the region of the largest diameter of the shaft boot, which at least partially covers the axial region of the fold. An encircling collar of this kind provides additional protection against stone impact and prevents stones or other foreign bodies from entering the region of the fold and damaging it or settling there.

Constructing the shaft boot in the manner described makes it possible to achieve improved sealing of the transition between the drive shaft and the joint. By virtue of its shaping, the shaft boot has only a minimum axial extent. The reservoir of material required for the mobility of the boot is stored primarily in one or more folds, these folds being arranged in the radial direction rather than adjacent to one another in the axial direction as in the prior art. Here, use is made of the fact that the joint has a larger diameter than the drive shaft, allowing the difference in diameters that has to be overcome to be used to accommodate the folds.

The radial in-series arrangement of folds concentrically surrounding the drive shaft furthermore has a positive effect on the lubricating properties, especially of a constant velocity joint. On the one hand, the empty volume located toward the constant velocity joint and surrounded by the shaft boot is considerably smaller than with the shaft boots known from the prior art owing to the short axial overall length of the shaft boot, with the result that there is less empty volume to hold lubricants. On the other hand, the shape of the folds has the effect that, when the drive shaft moves, any lubricant in the folds is forced out of the folds in the direction of the constant velocity joint, making it available once again for its true purpose.

Owing to its bellows-type construction, the shaft boot according to the invention is also suitable for joints that have an axial degree of freedom.

The axial extent of the folded portion of the shaft boot according to the invention is preferably 50% to 950%, particularly preferably 60% to 80%, of the diameter of the drive shaft. In this context, the diameter at that point on the drive shaft at which the shaft boot is secured by its second end is taken as the basis for the diameter of the drive shaft. It is thus possible to achieve a very short axial overall length with the shaft boot designed in accordance with the invention.

According to a development of the invention, a clamping element is arranged at at least one end of the shaft boot, it being possible, in particular, for this clamping element to be ring- or sleeve-shaped and to be used to produce a radially inward contact pressure to secure the shaft boot on the drive shaft or the constant velocity joint. The clamping element is produced from a suitable elastic material such as, in particular, a metal. The clamping element is preferably integrated into the flexible material of the shaft boot. The clamping element makes it possible to achieve a considerable reduction in the effort involved in fitting the shaft boot as compared with the systems known from the prior art. The dimensioning of the clamping element is chosen so that the diameter of the shaft boot is significantly smaller in the region of the clamping element than the diameter at the contact point on the shaft or constant velocity joint, where the clamping element is supposed to rest. Before the fitting of the shaft boot, the opening of the clamping element is widened accordingly, and the shaft boot is placed in the desired position on the drive shaft or the constant velocity joint. Once it has reached the desired position, the fitting aid used (e.g. a tool operating on the principle of a shoehorn) is removed or pulled out. The clamping element then assumes its original, narrower, shape and thereby presses the shaft boot firmly onto its support. As a result, the shaft boot provides complete and permanently reliable sealing and is secured against slipping. Another advantage is the greater uniformity of fastening in comparison with known fastening methods, in which a type of hose clamp or a cable strap clamps the shaft boot firmly on its underlying support. With the last-mentioned fastening methods, crushing repeatedly occurs in the region of the screw or of the roll-up device, damaging the underlying shaft boot.

The wall thickness of the shaft boot can decrease in the radially outward direction, thereby optimizing the distribution of forces in the bellows-shaped portion of the shaft boot.

A refinement of the invention provides a shaft boot for sealing off the transition between a drive shaft and a constant velocity joint that is composed essentially of a polyurethane foam. A polyurethane foam has the advantage of being compressible but light in weight and having sufficient flexibility. Moreover, it can survive a large amount of mechanical damage, e.g. cuts or tears, without impairment of its functioning, since it closes up again more or less spontaneously.

### BRIEF DESCRIPTION OF DRAWINGS

The invention is explained below by way of example with the aid of the figures, in which:

FIG. 1 shows a shaft boot according to the invention at the transition from a drive shaft to a constant velocity joint;

FIG. 2 shows a possible angular position between the drive shaft and the constant velocity joint, and

FIG. 3 shows a shaft boot according to the invention similar to that illustrated in FIG. 1 but without an additional protective collar.

### DETAILED DESCRIPTION

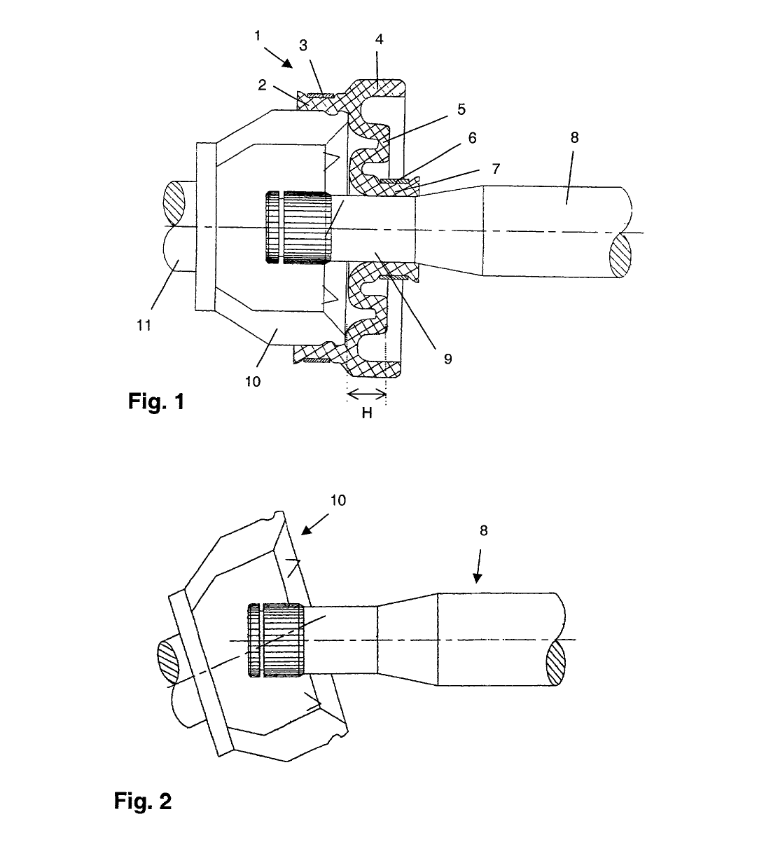

FIG. 1 shows a side view of a constant velocity joint 90, which makes the connection between an incoming shaft 99 and an outgoing drive shaft 8. The constant velocity joint 90 couples the two shafts 8, 99 in a known manner that is not explained in detail here, in such a way that an angular misalignment can occur between the axes of these two shafts without impairing or interrupting the transmission of rotary motion. An illustrative angular misalignment of about 20 between the axes can be seen in FIG. 2.

FIG. 1 furthermore shows a cross section through a shaft boot 9 according to the invention, which seals and protects the transition from the constant velocity joint 90 to the drive shaft 8. The shaft boot 9, which is preferably composed of polyurethane foam, is secured by its first end 2 on the outer circumference of the housing of the constant velocity joint 90. It is secured by its second end 7 on the drive shaft 8. This second end 7 is seated on a portion 9 of the drive shaft 8, the radius of which is smaller than that of the rest of the drive shaft.

The shape of the shaft boot 9 can be described essentially as follows: the radial outside of the shaft boot 9 is formed by a sleeve-shaped part, which includes said first end 2 and a collar 4 projecting axially away from the constant velocity joint 90. The radially inner portion of the shaft boot 9 is likewise sleeve-shaped and is formed by the second end 7 of the shaft boot. The radially inner sleeve 7 and the radially outer sleeve 2, 4 of the shaft boot, which end approximately flush in the axial direction of the drive shaft 8 (on the right in the figure), are connected by a continuous piece of material, which forms a fold 5. The fold 5 points axially away from the constant velocity joint 90 (to the right in the figure) and encircles the drive shaft 8 concentrically. The fold 5 lies completely within the annular volume enclosed between the inner sleeve 7 and the outer sleeve 4 of the shaft boot.

By virtue of the shaping of the shaft boot as described, it has a very short axial overall length and therefore takes up very little space. The radial accommodation of the fold 5 and its minimal axial extent furthermore ensures that the volume on the inside of the shaft boot 9 is very small, ensuring that only a very small amount of lubricating grease from the constant velocity joint 90 can accumulate there. Moreover, any lubricating grease in the fold 5 or any other interspaces is forced out of these spaces during a pivoting motion of the drive shaft 8 and fed back to the constant velocity joint. There it can perform its true function and lubricate ball bearings, for example. With the shaft boot according to the invention, therefore, the requirement for lubricant is lower and the exploitation of the lubricant present is greater.

Thanks to its compact design and the fact that it is supported on the constant velocity joint and the drive shaft, the shaft boot according to the invention furthermore has greater stability. As a result, it is possible, in particular, to provide better protection against stresses such as stone impact, for example. Stone impact protection is additionally improved by the outer collar 4 of the shaft boot.

The shaft boot is secured on the housing of the constant velocity joint 90 and on the drive shaft 8 by means of sleeve-shaped clamping elements 3 and 6. Clamping elements of this kind produce a contact pressure in the radially inward direction that presses the shaft boot onto its underlying support. The clamping elements6 can be rounded at the edge to reduce the extent to which they cut into the material of the shaft boot. These clamping elements are preferably composed of a material with little tendency to stretch, e.g. a metal. They can be molded onto or embedded in the material of the shaft boot. The fitting of the shaft boot therefore does not require separate fastening means such as hose clamps or the like, and completely uniform fastening is achieved over their circumference.

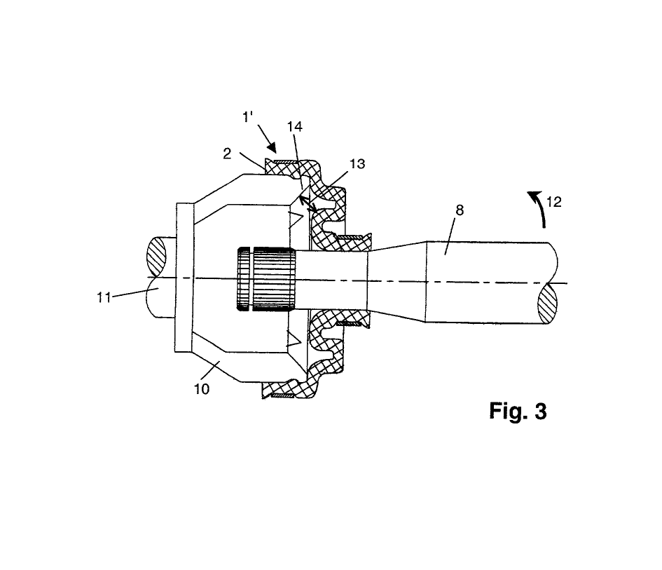

FIG. 3 illustrates a shaft boot 9′ similar to that in FIG. 9 but without a protective collar.

One advantage of the shaft boot 9 according to the invention is that it protects the joint 90 in the event of extreme deflections. In the workshop, the procedure when removing the vehicle's transmission is as follows, for example: the lower guide of the suspension struts is removed, while the universally jointed shafts with the wheel hub remain connected to the suspension strut. The entire unit is then moved outward, with the result that the inner joints are pulled out of the transmission. During this process, the outer joints can be deflected to the maximum extent if they are hanging down, for example, as indicated by arrow 92 in FIG. 3. During this process, the lever action can give rise to large forces that may damage the constant velocity joint 90. During such deflections, the bellows according to the invention comes to rest on the tapered surface 94 (bell) of the constant velocity joint 90 approximately at the point indicated by arrow 93 and thus acts as a spacer to prevent extreme deflections of and damage to the constant velocity joint. By virtue of the flexibility of the material of the shaft boot, the impact of the universally jointed shaft on the surface 94 in the case described above is furthermore damped.

The wall thickness of the shaft boot 9 can decrease in the radially outward direction, thereby optimizing the distribution of forces in the bellows-shaped portion of the shaft boot.

The shaft boot 9 is preferably composed of a polyurethane foam. This material is highly compressible and, unlike the materials known from the prior art, is not a consistent elastomer. This choice of material leads inter alia to self-sealing properties that do not entail a loss of the sealing characteristics even in the case of limited external destruction. This material can even withstand being cut into with a knife without losing its separating action (lubricating grease on the inside, dirt on the outside). Another advantage of this selection of material is that it ensures excellent protection against stone impact by the shaft boot.

The material of the shaft boot can be made permeable to air, at least in partial areas, this being relatively easy to achieve with polyurethane foam, thus allowing excess pressure generated by a rise in temperature due to operation to dissipate.

In summary, the shaft boot 9 according to the invention thus offers the following advantages:

reduced quantity of grease;

simplified fitting through a reduction in the number of parts, simplification of the parts and the use of integral clamping rings;

reduction in weight since less lubricant is required;

maintenance of lubricating properties through return of the grease from the fold;

smaller overall volume;

greater durability;

smaller area of attack for possible intrusion, stone impact etc.;

optimum suitability for stacking, storage and transportation since the shaft boots can be nested and stored like “soup bowls”;

if polyurethane foam is used, its properties, especially its high compressibility, help to secure, fix and seal the shaft boot;

the sealing action of a PU boot is maintained even when it is damaged (tear etc.);

cost and weight saving by elimination of material from the shaft boot thanks to the lower density of PU foam.

1. A shaft boot for sealing off the transition between a drive shaft and a joint having a larger diameter than the drive shaft, the shaft boot comprising:
a first end securable to the joint;
a second end securable to the drive shaft;
at least one fold connecting the first end and the second end and pointing away from the joint, the fold concentrically surrounding at least a portion of the second end of the shaft boot; and
a collar extending axially from the first end toward the second end and concentrically surrounding at least a portion of the fold.

2. The shaft boot as claimed in claim 1 wherein the fold has an axial extent equal to approximately 50% to 950% of a diameter of the drive shaft.

3. The shaft boot as claimed in claim 2 wherein the axial extent of the fold is equal to approximately 60% to 80% of the diameter of the drive shaft.

4. The shaft boot as claimed in any of claims 9 further comprising a clamping element on at least one of the first and second ends of the shaft boot to exert a radial contact pressure between the shaft boot and at least one of the shaft and the joint.

5. The shaft boot as claimed in claim 4 wherein the clamping element is integrated into the material of the shaft boot.

6. The shaft boot as claimed in any of claims 9 wherein the thickness of the material of the shaft boot decreases toward the outside.

7. The shaft boot as claimed in any of claims 9 wherein the boot is composed primarily of a polyurethane foam.

8. The shaft boot as claimed in any of claims 9 wherein at least a portion of the boot is made of an air-permeable material.

9. A shaft boot for sealing off the transition between a drive shaft and a joint having a larger diameter than the drive shaft, the shaft boot comprising:
an inner sleeve securable around an outer surface of the shaft;
an outer sleeve having a first end securable around an outer surface of the joint and a collar projecting axially away from the joint to at least partially overlap the inner sleeve; and
a fold connecting the inner sleeve and the outer sleeve, the fold pointing axially away from the joint and disposed at least partially within an annular volume enclosed between the inner sleeve and the collar.

10. The shaft boot as claimed in claim 9 wherein the fold has an axial extent equal to approximately 50% to 150% of a diameter of the drive shaft.

11. The shaft boot as claimed in claim 10 wherein the axial extent of the fold is equal to approximately 60% to 80% of the diameter of the drive shaft.

12. The shaft boot as claimed in any of claims 9 further comprising a clamping element on at at least one of the first and second ends of the shaft boot to exert a radial contact pressure between the shaft boot and at least one of the shaft and the joint.

13. The shaft boot as claimed in claim 12 wherein the clamping element is integrated into the material of the shaft boot.

14. The shaft boot as claimed in any of claims 9 wherein the thickness of the material of the shaft boot decreases toward the outside.

15. The shaft boot as claimed in any of claims 9 wherein the boot is composed primarily of a polyurethane foam.

16. The shaft boot as claimed in any of claims 9 wherein at least a portion of the boot is made of an air-permeable material.
